(19) United States
(12) Patent Application Publication
(10) Pub. No.: US 2013/0191660 A1
(43) Pub. Date: Jul. 25, 2013

(54) ELECTRICAL SWITCH CONTROLLER WITH WIRELESSLY ADDRESSABLE WEB SERVER

(71) Applicants: Hai Pham, Eden Prairie, MN (US); Todd Hanson, Loretto, MN (US); Soumitri Kolavennu, Blaine, MN (US)

(72) Inventors: Hai Pham, Eden Prairie, MN (US); Todd Hanson, Loretto, MN (US); Soumitri Kolavennu, Blaine, MN (US)

(73) Assignee: HONEYWELL INTERNATIONAL INC., Morristown, NJ (US)

(21) Appl. No.: 13/357,949

(22) Filed: Jan. 25, 2012

(51) Int. Cl. G06F 1/26

(52) U.S. Cl. 713/310

(57) ABSTRACT

An electrical power switch includes a power switch body, an electrical power connector, an electrical power controller, a web server, and a wireless communication module. The electrical power controller is comprised in the power switch body and connected to the electrical power connector, and configured to control the electrical power connector. The web server is comprised in the power switch body and connected to the electrical power controller. The wireless communication module is comprised in the power switch body and connected to the web server.

### TECHNICAL FIELD

The disclosure relates to electrical power switches, and, more particularly, to electrical power switch controllers.

### BACKGROUND

Electrical assets of various kinds, such as pumps, actuators, appliances, heating systems and air conditioning systems (HVAC), refrigeration systems, remote terminal units (RTUs), and generators, to name a few, may be deployed indoors or in the open field. They may be deployed in a wide variety of locations, based on proximity to other assets or resources. Some electrical assets include components that draw relatively high currents (e.g., in the range of tens of amperes). For example, such devices may include motors, compressors, resistive heaters, boilers, or furnaces. Many electrical assets include an electrical switch controller of various kinds. For example, some electrical assets include temperature control systems with thermostat switches that detect and control temperature by selectively controlling the electrical switch for providing electric power to a heater. In some cases such as this one, the control switch for the electric power may be based on some form of electrical logic device and/or physical feedback control. In another example, an electrical switch controller for an irrigation pump may include a logic controller with a timer that may be set to deliver electric power to the pump at certain times and for certain intervals to pump water through an irrigation apparatus. Personnel may select the appropriate controller for electrical power when installing the asset, and may subsequently return to the asset to test, reconfigure, or maintain the controller.

### SUMMARY

An electrical power switch according to the present disclosure includes a web server and a wireless communication module. The electrical power switch controls electrical power delivered to an electrical load (such as a pump, a light, a resistive heater, etc.) according to control signals received via the wireless communication module and the web server.

In some examples, the present disclosure is directed to an electrical power switch that includes a power switch body, an electrical power connector, an electrical power controller, a web server, and a wireless communication module. The electrical power controller is included in the power switch body and connected to the electrical power connector, and configured to control the electrical power connector. The web server is also included in the power switch body and connected to the electrical power controller. In addition, the wireless communication module is included in the power switch body and connected to the web server.

In other examples, the present disclosure is directed to an electrical power switch control system. The electrical power switch control system includes a power switch body, an electrical power connector, an electrical power controller, a web server, a wireless communication module, and a client computing device. The electrical power connector is included in the power switch body. The electrical power controller is also included in the power switch body and connected to the electrical power connector, and configured to control the electrical power connector. The web server is included in the power switch body and connected to the electrical power controller. The web server is configured to execute a web application comprising information and control options associated with the electrical power controller, such that the web application is enabled to be rendered on the client computing device. The wireless communication module is included in the power switch body and connected to the web server. The client computing device is configured to establish a communicative connection with the web server over a packet data network and to render a client interface for the web application.

In other examples, the present disclosure is directed to a method of controlling an electrical power switch, which may be executed on a client device (e.g., a mobile computing device or another computer located remotely from the electrical power switch). The method includes executing a web application comprising information and one or more control options associated with an electrical power controller. The method further includes sending a signal through a wireless communication module to enable the web application to be accessed on a client computing device. The method further includes receiving an input to the one or more control options comprised in the web application through the wireless communication module. The method further includes communicating a control signal, based on the input to the one or more control options, to an electrical power controller. The method further includes controlling an electrical power connector from the electrical power controller based on the control signal.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a block diagram of an example electrical power switch comprising a web server and a wireless communication module.

FIG. 2 is a block diagram of an example field system that includes multiple electrically controlled assets under the control of wireless network accessible electrical power switches.

FIG. 3 is an illustrative view depicting a client computing device with a screenshot of a web application client interface for interacting with a web application running on a web server comprised in an electrical power switch.

FIG. 4 is a flow diagram of an example method for controlling an electrical power switch over a network and a wireless connection.

### DETAILED DESCRIPTION

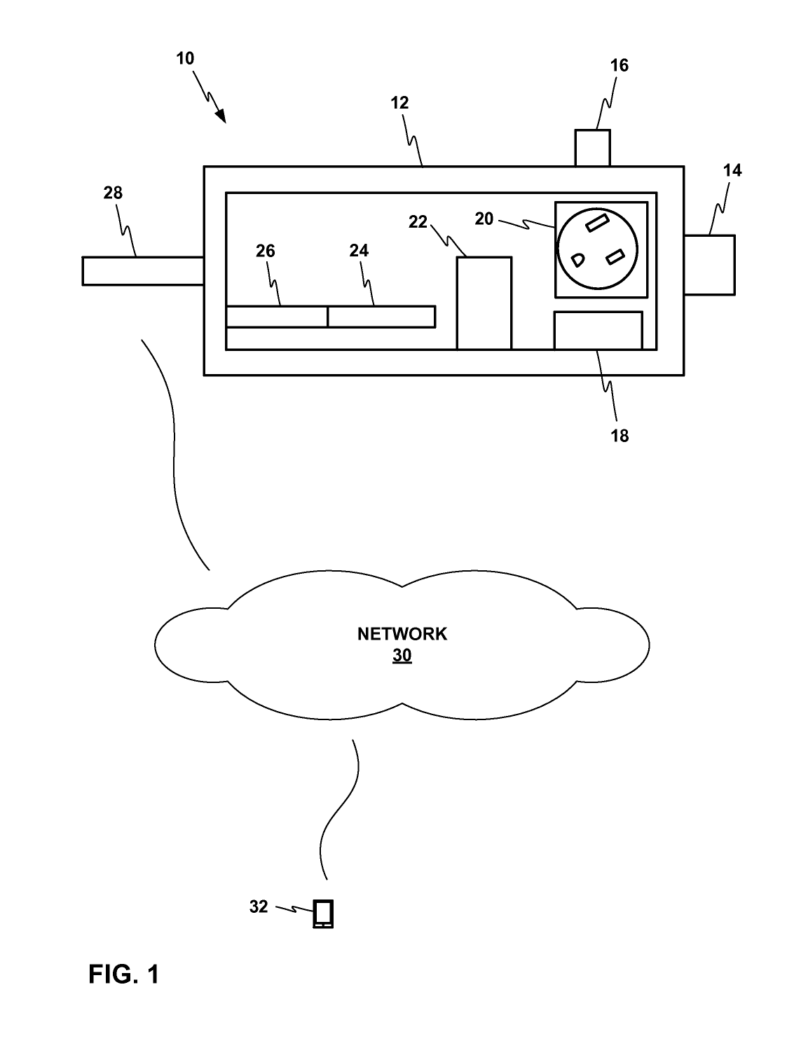

FIG. 1 is a block diagram of an electrical power switch 10 that includes a web server 24 and a wireless communication module 26, and that is enabled to establish a communicative connection through network 30 to a client computing device 32. Electrical power switch 10 also includes an electrical power controller 22, various electrical power connectors 14, 16, 18, and 20, and an antenna 28. Web server 24, wireless communication module 26, and electrical power controller 22 are housed within an electrically qualified power switch body 12. Power switch body 12 may be a metal or hard plastic case or housing that safely contains the components housed within it and protects those components from the exterior environment. Web server 24 is connected to the electrical power controller 22, and wireless communication module 26 is connected to web server 24. Electrical power connectors 14, 16, 18, and 20 and antenna 28 are also securely connected to power switch body 12. The electrical power connectors include line input power connector 14, supply power connector 16, relay module power connector 18, and load power connector 20, which is a receptacle with multiple sockets that electrical assets may be plugged into to draw electrical power through electrical power switch 10, from an electrical power source that may be connected to any one of line input power connector 14, supply power connector 16, or relay module power connector 18. Other electrical power switch examples may have any of a variety of types of electrical power connectors, and may have any number of one or more inbound electrical power connectors for connecting to sources of electrical power, and one or more outbound electrical power connectors for connecting an electrical load to, to provide electrical power to the load. Electrical power switch 10 may also include other components besides those discussed here and depicted in FIG. 1, such as a fuse, power switch, terminal blocks, transformer, intrinsically safe electrical components, or additional power control or communication circuitry.

Electrical power controller 22, which may take the form of a power control board (PCB), is connected to the electrical power connectors 14, 16, 18, and 20 and is configured to control electrical power connectors 14, 16, 18, and 20, such as by controlling whether an electrical connection is closed or open between various of electrical power connectors 14, 16, 18, and 20, and various amount of electrical power, voltage, or current is permitted to flow between any two of electrical power connectors 14, 16, 18, and 20. Electrical power controller 22 may be configured to control the flow of electricity from any of electrical power connectors 14, 16, 18 to electrical power connector 20. For convenience, electrical power connectors 14, 16, 18 may be collectively referred to as source connectors 14-18, and electrical power connector 20 may be referred to as a load connector. Electrical power controller 22 or electrical power switch 10 may also include an electrical adapter (e.g., an AC/DC converter) that is configured to receive AC voltage from line input power connector 14, which may be configured to take 90 to 250 VAC 50 to 75 Hz, and output various voltage from 3 to 50 VDC (e.g., 5V, 12V, 24V, 48V, or other voltages, or controlled for a set current source or a set power source rather than a set voltage) to load connector 20, for example.

Electrical power controller 22 may exert any of a variety of controls over the flow of electricity from one of the source connectors 14, 16, 18 to the load connector 20. Electrical power controller 22 may be configured to allow any amount of electrical power in a range from zero to the maximum available power, to flow from one of source connectors 14-18 to load connector 20. Electrical power controller 22 may be configured to control for either a level of electrical power, a level of electrical current, or a level of voltage that is provided by one of the source connectors 14-18. Given the voltage or current available from one of source connectors 14-18, electrical power controller 22 may be configured to provide anywhere from zero to the maximum available power, current, or voltage to the load connector 20. Electrical power controller 22 may also incorporate timing logic and be configured to control a duty cycle in which the load connector 20 operates, or in which the electrical power from one of source connectors 14-18 is provided to the load connector 20. In another example, electrical power controller 22 may also include a simple switch that can be closed to connect one of source connectors 14-18 to load connector 20, or opened to disconnect one of source connectors 14-18 from load connector 20.

In another example, a single electrical power switch may form a power strip that includes multiple load connectors to control multiple electrically controlled assets (not depicted in FIG. 1), and may have common controls or individually customized controls for each of its load connectors. In this case, its web server may provide a web application that can show either common or individual information and control options for the several load connectors.

Web server 24 may be configured to host a web page, to execute a web application comprising information and control options associated with the electrical power controller to be rendered on a client computing device. In another example, web server 24 may be configured to execute a web application comprising information associated with the electrical power controller but not and control options, or control options associated with the electrical power controller but not information. In another example, web server 24 may simply be configured to receive requests or other signals according to Hypertext Transfer Protocol (HTTP), Hypertext Transfer Protocol Secure (HTTPS), or another protocol used in network-based communication, and respond by sending out information about the status of electrical power switch 10, managing information, and sending control signals to electrical power controller 22.

Web server 24 may be configured to receive control inputs from a client interface running on a remote client computing device 32 via a web application and to send the control inputs to electrical power connector 22. Web server 24 may be configured to manage information, and execute the web application such that the information it provides includes a level of electrical power, a level of electrical current, or a level of voltage that is provided by the electrical power connector 22, or a duty cycle that the electrical power connector 22 is implementing, or information on all of these or any combination of these variables. Web server 24 may also be configured to execute the web application such that it provides control options to the client interface for modifying any of these variables.

Web server 24 is communicatively connected to wireless communication module 26, which is connected to antenna 28, enabling web server 24 to send and receive wireless signals. Wireless communication module 26 may take any of a number of forms. Wireless communication module 26 may be a WiFi module, a WiMAX (Worldwide Interoperability for Microwave Access) module, a Bluetooth, I.E.E.E. 802.15.4, ISP100, ZigBee, 61oPan module or other short-range wireless module, a 4G module, a 3G module, a 2G module, or any other type of module configured for sending and receiving license or non-license wireless signals in accordance with an appropriate wireless communication protocol or coding or transmission standard. The wireless communication may conform to orthogonal frequency division multiplexing (OFDM), time division multi access (TDMA), frequency division multi access (FDMA), code division multi access (CDMA), or any of a wide variety of other wireless communication protocols or standards. In some examples, wireless communication module 26 may include multiple modules for any two or more wireless communication protocols or standards. Network 30 may also include any number of routers, gateways, nodes, servers, and other assets, including wireless routers or wireless gateways, appropriate for conveying packet data signals through the cloud between electrical power switch 10 and client computing device 32.

The web server 24 may be configured with an Internet Protocol (IP) address, a default route, and a routing prefix. Web server 24 may be configured as an IPv4 host or as an IPv6 host. Web server may be configured to send and receive TCP packets, UDP packets, or both, or other protocols of data packets. Web server 24 may be configured according to Dynamic Host Configuration Protocol (DHCP). In another example, web server 24 has a static IP address which may not use DHCP, and may have an IP address on a local area network (LAN). Web server 24 may be programmed with a Media Access Control (MAC) address, an IP address, an IP network subnet setting, and an IP address of DNS, a gateway or router, for example. Inputs may be provisioning, hard coded or/and entered to web server 24 over the serial interface, Internet or other data packet network by interacting with a web application running on web server 24, or simply by requesting one or more Uniform Resource Locators (URLs) or other Uniform Resource Identifiers (URIs) on web server 24.

Electrical power switch 10 is thereby able to communicate information to mobile able client computing device 32 and receive signals from client computing device 32 over network 30. Device 32 may download and execute a client interface for the web application running on web server 24, or otherwise be configured to send HTTP requests or other signals to web server 24 and receive information and control options from web server 24. Electrical power switch 10 and device 32 running the client interface for communicating with web server 24 thereby work together to form an over the cloud electrical power switch control system.

Electrical power controller 22 may include any discrete and/or integrated electronic circuit components that implement analog and/or digital circuits capable of producing the functions attributed herein to electrical power controller 22. For example, electrical power controller 22 may include analog circuits, e.g., amplification circuits, filtering circuits, and/or other signal conditioning circuits. Electrical power controller 22 may also include digital circuits, e.g., combinational or sequential logic circuits, memory, etc. Memory may include any volatile, non-volatile, magnetic, or electrical medium, such as a random access memory (RAM), read-only memory (ROM), non-volatile RAM, electrically-erasable programmable ROM (EEPROM), flash memory, or any other memory component. Furthermore, a memory component may include instructions that, when executed by one or more processing circuits of electrical power controller 22, cause electrical power controller 22 to perform various functions attributed herein to electrical power controller 22.

Electrical power controller 22 may control a control switch in order to control the electricity supplied between any two or more of electrical power connectors 14, 16, 18, and 20. For example, electrical power controller 22 may include a metal-oxide-semiconductor field-effect transistor (MOSFET), FET, dry relay contacts. Electrical power controller 22 may close its control switch to connect any two or more of electrical power connectors 14, 16, 18, and 20, such as to connect line input power connector 14 with load connector 20. In some examples, electrical power controller 22 may be a high current connector capable of high current switching, in the range of one ampere or more or tens of amperes, e.g., 1 Amp or more. Electrical power controller 22 may also open its control switch, such as to disconnect line input power connector 14 from load connector 20, and therefore cut off the flow of electricity to any electrically controlled asset connected to load connector 20.

In other examples, electrical power controller 22 may operate in a continuous manner instead of a discrete on/off manner. For an example in which electrical power controller 22 includes a MOSFET switch, electrical power controller 22 may vary an amount of voltage at the gate of the MOSFET to vary a current provided to load connector 20, thereby controlling load connector 20, and any electrically controlled asset connected to it, in a continuous manner, as opposed to powering load connector 20 using a discrete on/off voltage. Electrical power controller 22 may also include sensors, such as a current sensor, a voltage sensor, etc. that independently sense the current, voltage, or power flowing through or between any of the electrical power connectors 14, 16, 18, and 20, the temperature of any of electrical power connectors 14, 16, 18, and 20 or of any other location within electrical power switch 10, or other variables, that it may use to provide to web server 22 for information to be provided to a mobile able client computing device.

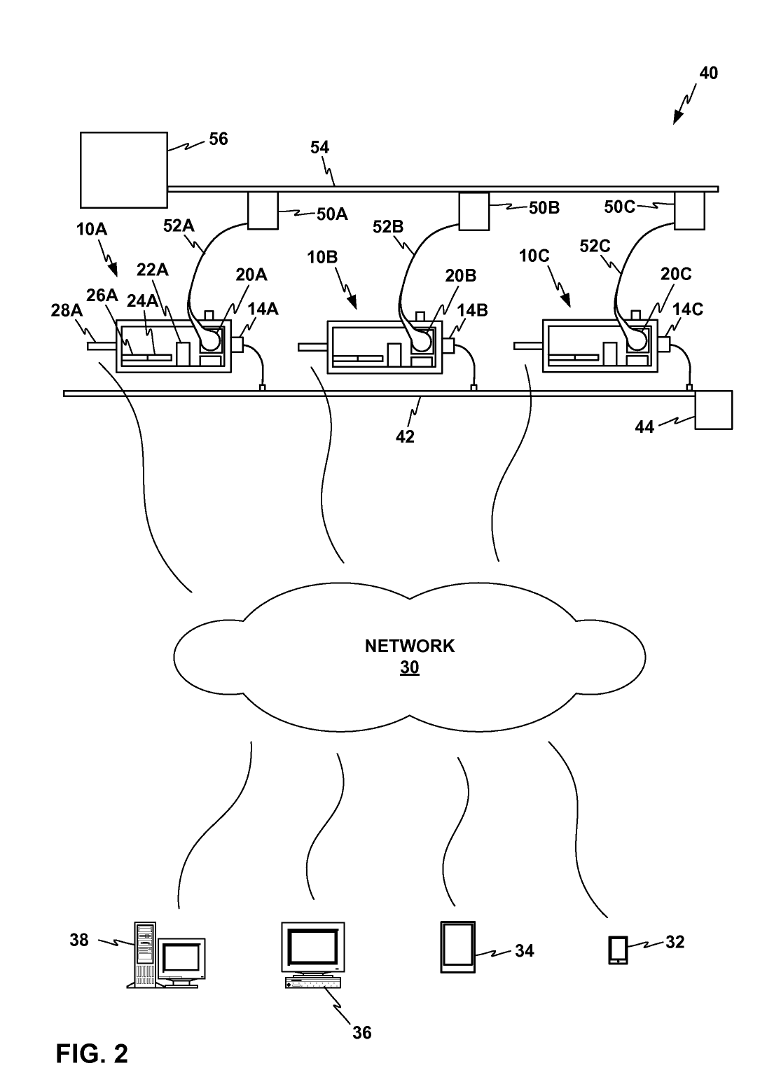

FIG. 2 is a block diagram of an example field system 40 that includes multiple electrically controlled assets, in the form of pumps 50A, 50B, and 50C (50A-50C) in this example, under the control of wireless network accessible electrical power switches 10A, 10B, and 10C (10A-10C). Electrical power switches 10A-10C are similar to electrical power switch 10 of FIG. 1. Representative electrical power switch 10A includes line input power source connector 14A, load power connector 20A, electrical power controller 22A, web server 24A, wireless communication module 26A, and antenna 28A. Electrical power switches 10A, 10B, and 10C are all enabled to communicate wirelessly over network 30 with any of a wide variety of client computing devices, represented here by client computing device 32 in the form of a smartphone, a tablet computer 34, a laptop computer 36, and a desktop computer 38. Mobile able client computing devices may also include dedicated wireless terminals, netbook computers, set-top boxes, televisions enabled with internal processors, other mobile phones or mobile devices, or any other type of processing device.

Electrical power switches 10A-10C are connected, through their line input power source connectors 14A, 14B, 14C, to an electrical power source 44 through an electrical line 42. Electrical power source 44 may be a battery, power generator, or a connection to another electrical power source, and may provide any of a range of voltage or current. Electrical power source 44 may provide 110/120/208/220/240 VAC or other AC source, or DC voltage from 3 to 100 VDC or other voltages, or a set current source or set power source. Electrical power switches 10A-10C may each control the electricity received from electrical power source 44 to provide through their load connectors 20A, 20B, 20C (20A-20C).

Pumps 50A-50C may be plugged into load connectors 20A-20C of electrical power switches 10A-10C through electrical plugs 52A, 52B, 52C, respectively. Pumps 50A-50C may also be connected to a water source 56 through water line 54 to pump water in an irrigation setting. The activity of pumps 50A-50C may therefore be controlled by electrical power switches 10A-10C, and in turn, may therefore be controlled using any of client computing devices 32-38 using a client interface with electrical power switches 10A-10C. A user of one of client computing devices 32-38, anywhere in the world, may be able to view and control the power, duty cycle, a schedule for turning on and off, or any of a variety of other factors for the operation of any of pumps 50A-50C.

Additionally, while only three pumps 50A-50C are depicted in FIG. 2, a field setting with one, two, four, a hundred, a thousand, or any other number of pumps may also be connected with wireless web-enabled electrical power switches that provide information and control options to any type of client computing device. Also, while pumps for an irrigation setting are referenced in regard to FIG. 2 as an illustrative use case, wireless web-enabled electrical power switches may be used to control any type of electrically controlled assets, including compressors, lights, motors, motor starters, heaters, dampers, valves, actuators, other HVAC devices or components, etc. With the wireless web-enabled electrical power connectors connected to any of these electrically controlled assets, the electrical power controllers control the flow of electricity to the electrically controlled asset and may provide information and control options for the electricity provided to those electrically controlled assets to any appropriate client computing device in the world.

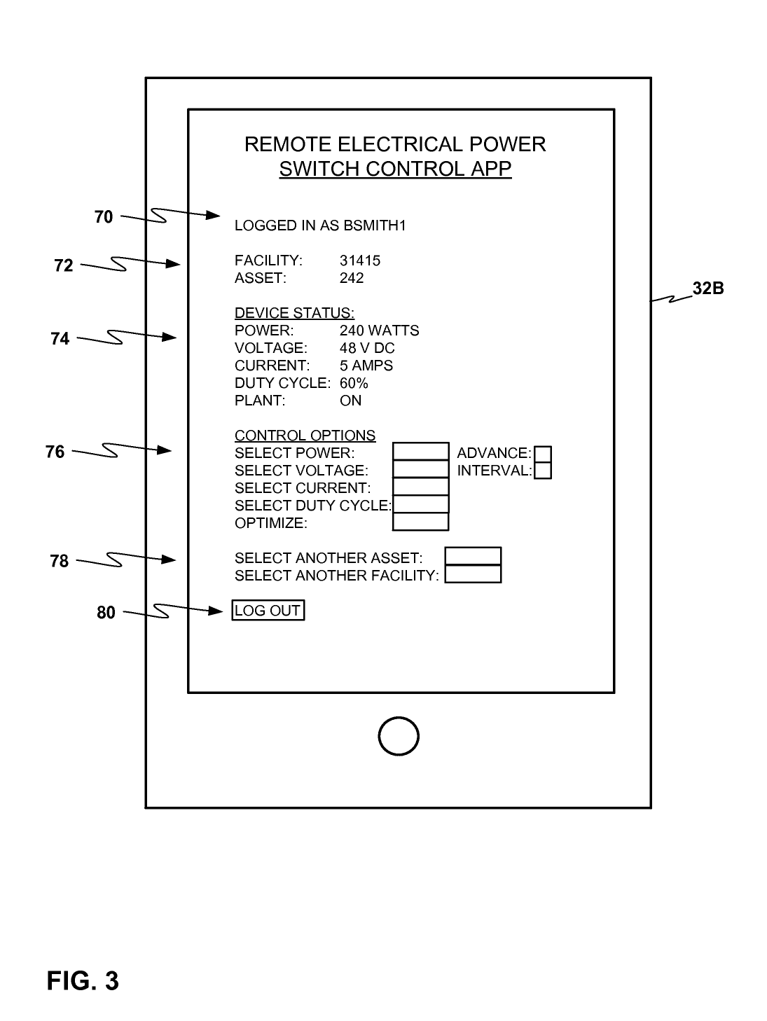

FIG. 3 depicts a client computing device 32B with a screenshot of a web application client interface for interacting with a web application running on a web server comprised in an electrical power switch, such as web server 22 in electrical power switch 10 or web server 22A in electrical power switch 10A as described above and as depicted in FIGS. 1 and 2. As FIG. 3 shows, the web application interface includes an indication 70 of a user who is logged into the interface, who may log in by entering a user name and password on a login page (not shown in FIG. 3), for example. The interface may show information, at 72, on a particular facility or field, and a particular electrically controlled asset or a particular electrical power switch to which an electrically controlled asset is connected, that the user may have selected. The interface may show information, at 74, on device statuses from the selected switch (or selected asset connected to the switch), including current statuses of electrical power, voltage, current, duty cycle, and plant ON/OFF status. The interface may also display additional information, such as a more detailed schedule for the selected switch or asset to be turned on or off or to be turned to different levels of power, or past statuses at different points in time, for example (not shown in FIG. 3). For purposes such as these, the selected electrical power switch may store information in a memory or data storage component within the electrical power switch that may be accessed by its internal web server, or it may coordinate with one or more additional computing devices or data storage devices.

As FIG. 3 further depicts, the web application client interface running on client computing device 32B also displays control options at 76. These include control options to select the level of electrical power, or of voltage, or of current for the switch to provide. The interface may also provide information on the maximum available of each of these variables, may include specific options for multiple incoming or outgoing electrical connectors, or may include recommended values or ranges for certain electrically controlled assets, such as a recommended range of duty cycles for a switch controlling an air conditioner (not shown in FIG. 3). The control options also include an option to select the duty cycle, which may be selectable anywhere from 0 to 100%, and an option to optimize for a selected one of the variables. While simple input fields are shown in FIG. 3, the web application client interface may also include other user interface elements such as sliders, buttons, or keypads in other examples.

The user of client computing device 32B may enter inputs to any of the control options at 76, and the client computing device 32B communicates those inputs over a network to the corresponding electrical power switch, where the switch's internal web server receives the input and translates it into a control signal that it sends to the switch's electrical power controller to put the input into effect. For example, the user may enter “0” in the input field for the control option to “select power”, and once that input has been communicated to the electrical power switch over the network, the web server may signal to the electrical power controller within the electrical power switch to open a switch between, e.g., a line connector and a load connector. The user may subsequently enter “40%” in the input field for the control option to “select duty cycle”, and the client computing device 32B communicates that input over a network to the electrical power switch, where the web server translates that input into a control signal to the electrical power controller to implement a 40% duty cycle for the electrical connection.

The interface also displays options at 78 to select another electrically controlled asset (i.e., the electrical power switch controlling that asset) or to select another facility, and displays a button 80 to log out. Different implementations of a web application client interface may display any portion of the information, control options, and other features displayed in the example of FIG. 3, and any of a variety of other types of information, control options, and other features. As noted in regard to FIG. 2, mobile able client computing devices may also include any of a wide variety of processing devices, including desktop computers, laptop computers, tablet computers, dedicated wireless terminals, netbook computers, set-top boxes, televisions enabled with internal processors, other mobile phones or mobile devices, or any other type of processing device.

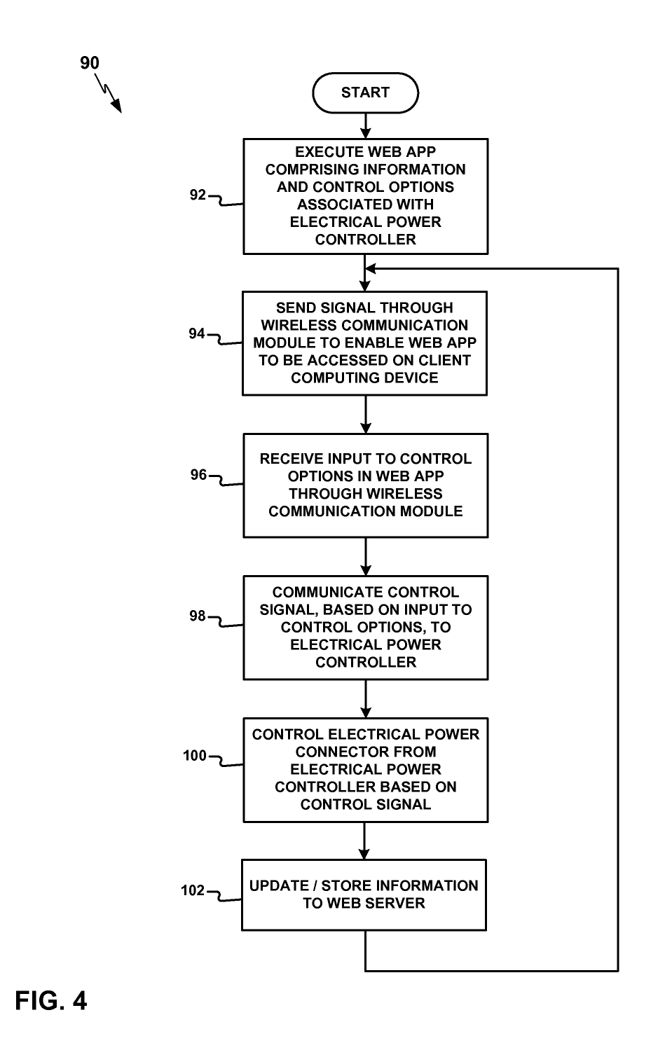

FIG. 4 is a flow diagram of an example method 90 for controlling an electrical power switch over a network and a wireless connection. As shown in FIG. 4, an electrical power switch, such as electrical power switches 10, 10A-10C of FIGS. 1 and 2, comprising its own internal web server may execute a web application comprising information and one or more controllable options associated with its electrical power controller (92). The electrical power switch sends a signal through a wireless communication module to enable the web application to be accessed on a client computing device, such as client computing devices 32, 34, 36, 38, 32B of FIGS. 1-3 (94). The electrical power switch receives an input to the one or more control options comprised in the web application through the wireless communication module (96). The electrical power switch communicates a control signal based on the input to an electrical power controller (98). The electrical power switch controls an electrical power connector from the electrical power controller based on the control signal (100). The electrical power switch may also update or store all the information on its internal web server (102).

The electrical power switch thereby enables a user with a client computing device anywhere in the world, with appropriate network access, to control the electrical power switch, and any electrically controlled asset connected to it. The information comprised in the web application may include any one or more of a level of electrical power, a level of electrical current, and a level of voltage that is provided by the electrical power connector. The one or more controllable options comprised in the web application include one or more of an option to control the level of electrical power provided by the electrical power connector, an option to control the level of electrical current provided by the electrical power connector, and an option to control the voltage provided by the electrical power connector.

Although a few examples have been described in detail above, other modifications or examples are possible consistent with this disclosure. For example, the flow diagram depicted in the figures does not require the particular order shown. Other steps may be provided, or steps may be eliminated, from the described flow diagram, and other components may be added to, or removed from, the described systems. Various other embodiments may be comprehended within the scope of the following claims.

What is claimed is:

1. An electrical power switch comprising:
a power switch body;
an electrical power connector;
an electrical power controller comprised in the power switch body and connected to the electrical power connector, and configured to control the electrical power connector;
a web server comprised in the power switch body and connected to the electrical power controller; and
a wireless communication module comprised in the power switch body and connected to the web server.

2. The electrical power switch of claim 1, wherein the web server is configured to execute a web application comprising information and control options associated with the electrical power controller to be rendered on a client computing device.

3. The electrical power switch of claim 2, wherein the web server is further configured to receive control inputs via the web application and to send the control inputs to the electrical power connector.

4. The electrical power switch of claim 2, wherein the web server is further configured to execute the web application such that the information comprises a level of electrical power that is provided by the electrical power connector.

5. The electrical power switch of claim 2, wherein the web server is further configured to execute the web application such that the information comprises a level of electrical current that is provided by the electrical power connector.

6. The electrical power switch of claim 2, wherein the web server is further configured to execute the web application such that the information comprises a level of voltage and an amount of current that is provided by the electrical power connector.

7. The electrical power switch of claim 1, wherein the electrical power connector comprises a line power connector and a load power connector.

8. The electrical power switch of claim 1, wherein the electrical power connector comprises a high voltage connector.

9. The electrical power switch of claim 1, wherein the electrical power connector comprises a high current connector.

10. The electrical power switch of claim 1, wherein the electrical power connector comprises a relay module.

11. The electrical power switch of claim 1, wherein the wireless communication module comprises a WiFi module.

12. The electrical power switch of claim 1, wherein the wireless communication module comprises at least one of a WiFi module, a WiMAX module, a Bluetooth module, an I.E.E.E. 802.15.4 module, an ISP100 module, a ZigBee module, a 61oPan module, a 4G module, a 3G module, or a 2G module.

13. The electrical power switch of claim 1, wherein the electrical power controller is configured to control one or more of a level of electrical power, a level of electrical current, or a level of voltage that is provided by the electrical power connector.

14. The electrical power switch of claim 1, wherein the electrical power controller is configured to control a duty cycle in which the electrical power connector operates.

15. A electrical power switch control system comprising:
a power switch body;
an electrical power connector comprised in the power switch body;
an electrical power controller comprised in the power switch body and connected to the electrical power connector, and configured to control the electrical power connector;
a web server comprised in the power switch body and connected to the electrical power controller, wherein the web server is configured to execute a web application comprising information and control options associated with the electrical power controller, such that the web application is enabled to be rendered on a client computing device;
a wireless communication module comprised in the power switch body and connected to the web server; and
a client computing device configured to establish a communicative connection with the web server over a packet data network and to render a client interface for the web application.

16. The electrical power switch control system of claim 15, wherein the web server is further configured to execute the web application such that the information comprises a level of electrical power, a level of electrical current, and a level of voltage that are provided by the electrical power connector.

17. The electrical power switch control system of claim 15, wherein the web server is further configured to receive control inputs from the web application and send the control inputs to the electrical power connector.

18. The electrical power switch control system of claim 15, further comprising an electrically controlled asset comprising a pump, a compressor, a light, a motor, a heater, a damper, a valve, or an actuator, and wherein the electrical power connector is connected to the electrically controlled asset, and the electrical power controller controls a flow of electricity to the electrically controlled asset.

19. A method of controlling an electrical power switch, the method comprising:
executing a web application comprising information and one or more control options associated with an electrical power controller;
sending a signal through a wireless communication module to enable the web application to be accessed on a client computing device;
receiving an input to the one or more control options comprised in the web application through the wireless communication module;
communicating a control signal, based on the input to the one or more control options, to an electrical power controller; and
controlling an electrical power connector from the electrical power controller based on the control signal.

20. The method of claim 19, wherein the information comprised in the web application comprises one or more of a level of electrical power, a level of electrical current, and a level of voltage that is provided by the electrical power connector, and wherein the one or more control options comprised in the web application comprise one or more of an option to control the level of electrical power provided by the electrical power connector, an option to control the level of electrical current provided by the electrical power connector, and an option to control the voltage provided by the electrical power connector.
